(19) United States
(12) Patent Application Publication
(10) Pub. No.: US 2020/0309540 A1
(43) Pub. Date: Oct. 1, 2020

(54) MAP INFORMATION DISTRIBUTION SYSTEM AND VEHICLE

(71) Applicant: TOYOTA JIDOSHA KABUSHIKI KAISHA, Toyota-shi (JP)

(72) Inventors: Shin SAKURADA, Toyota-shi (JP); Sinae KIM, Nagoya-shi (JP); Takayuki YANO, Nisshin-shi (JP); Naoki YAMAMURO, Nagoya-shi (JP); Takashi HAYASHI, Aichi-gun (JP); Koji MIYATA, Nagoya-shi (JP)

(73) Assignee: TOYOTA JIDOSHA KABUSHIKI KAISHA, Toyota-shi (JP)

(21) Appl. No.: 16/817,530

(22) Filed: Mar. 12, 2020

(30) Foreign Application Priority Data
Mar. 29, 2019 (JP) 2019-066907

(51) Int. Cl. G01C 21/32; G01C 21/00; H04W 4/40

(52) U.S. Cl. CPC G01C 21/32; H04W 4/40; G01C 21/005

(57) ABSTRACT

In a map information distribution system, a server device distributes map information to a vehicle through a telecommunication network. The vehicle includes a control device configured to: determine whether there is missing data in the map information held by the vehicle; determine, when there is missing data in the map information held by the vehicle, whether a nearby vehicle holds the missing data by communicating with the nearby vehicle; acquire the missing data from the nearby vehicle, when the nearby vehicle holds the missing data; and acquire the missing data from the server device, when the nearby vehicle does not hold the missing data.

### INCORPORATION BY REFERENCE

The disclosure of Japanese Patent Application No. 2019-066907 filed on Mar. 29, 2019 including the specification, drawings and abstract is incorporated herein by reference in its entirety.

### BACKGROUND

### 1. Technical Field

The disclosure relates to a map information distribution system in which a server device distributes map information to a vehicle through a telecommunication network, and relates also to a vehicle.

### 2. Description of Related Art

Japanese Unexamined Patent Application Publication No. 11-203597 (JP 11-203597 A) describes a system in which, when there is missing data in map information (i.e., at least one piece of data is missing in the map information), a vehicle acquires the missing data from a server device through a telecommunication network.

### SUMMARY

In the system described in JP 11-203597 A, the vehicle needs to communicate with the server device through the telecommunication network every time there is missing data in the map information. As a result, the data traffic between the vehicle and the server device becomes significantly heavy.

The disclosure provides a map information distribution system and a vehicle that are configured to reduce the data traffic between the vehicle and a server device.

An aspect of the disclosure relates to a map information distribution system in which a server device distributes map information to a vehicle through a telecommunication network. The vehicle includes a control device configured to: determine whether there is missing data in the map information held by the vehicle; determine, when there is missing data in the map information held by the vehicle, whether a nearby vehicle holds the missing data by communicating with the nearby vehicle; acquire the missing data from the nearby vehicle, when the nearby vehicle holds the missing data; and acquire the missing data from the server device, when the nearby vehicle does not hold the missing data.

In the map information distribution system according to the above aspect, the control device may communicate with a nearby vehicle holding map information in a version newer than a version of the map information held by the vehicle, among nearby vehicles. The control device may communicate with a nearby vehicle having a destination similar to a destination of the vehicle, among nearby vehicles. With these configurations, it is possible to increase the probability of acquiring the missing data from the nearby vehicles.

Another aspect of the disclosure relates to a vehicle including a control device configured to: determine whether there is missing data in map information held by the vehicle; determine, when there is missing data in the map information, whether a nearby vehicle holds the missing data by communicating with the nearby vehicle; acquire the missing data from the nearby vehicle, when the nearby vehicle holds the missing data; and acquire the missing data from the server device, when the nearby vehicle does not hold the missing data.

With the map information distribution system and the vehicle according to the above aspects, it is possible to avoid a situation where, every time there is missing data in the map information, the vehicle acquires the missing data from the server device. As a result, it is possible to reduce the data traffic between the vehicle and the server device.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic diagram illustrating the configuration of a map information distribution system according to an embodiment of the disclosure;

FIG. 2 is a block diagram illustrating the configuration of a vehicle illustrated in FIG. 1;

FIG. 3 is a block diagram illustrating the configuration of a server device illustrated in FIG. 1; and

FIG. 4 is a flowchart illustrating the procedure of a map information acquisition process according to the embodiment of the disclosure.

### DETAILED DESCRIPTION OF EMBODIMENTS

Hereinafter, the configuration of a map information distribution system 1 according to an embodiment of the disclosure will be described with reference to the accompanying drawings.

Overall Configuration

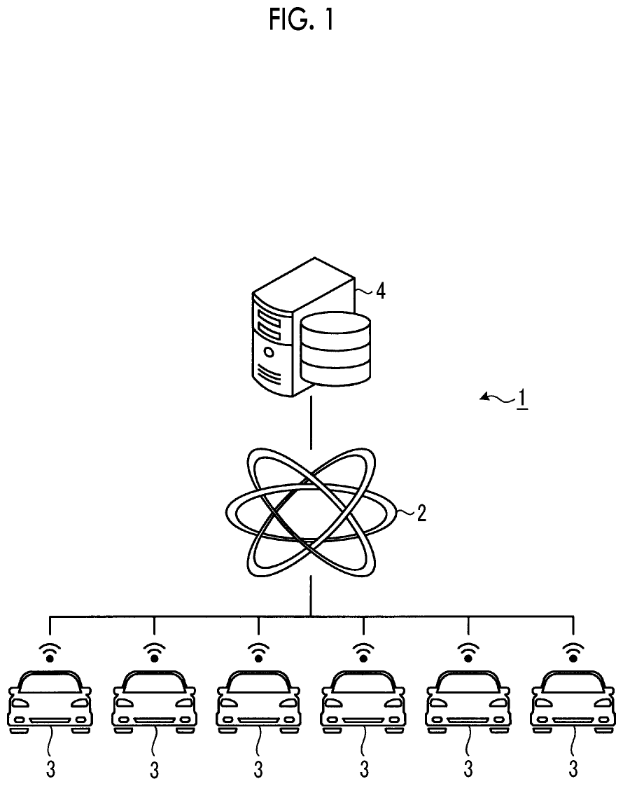

First, the overall configuration of the map information distribution system 1 according to the embodiment of the disclosure will be described with reference to FIG. 1.

FIG. 1 is a schematic diagram illustrating the configuration of the map information distribution system 1 according to the embodiment of the disclosure. As illustrated in FIG. 1, the map information distribution system 1 according to the embodiment of the disclosure is a system in which a server device 4 distributes map information to vehicles 3 through a telecommunication network 2, such as the Internet or a cellular network, and the map information distribution system 1 includes a plurality of the vehicles 3 and the server device 4, as main components.

Configuration of Vehicle

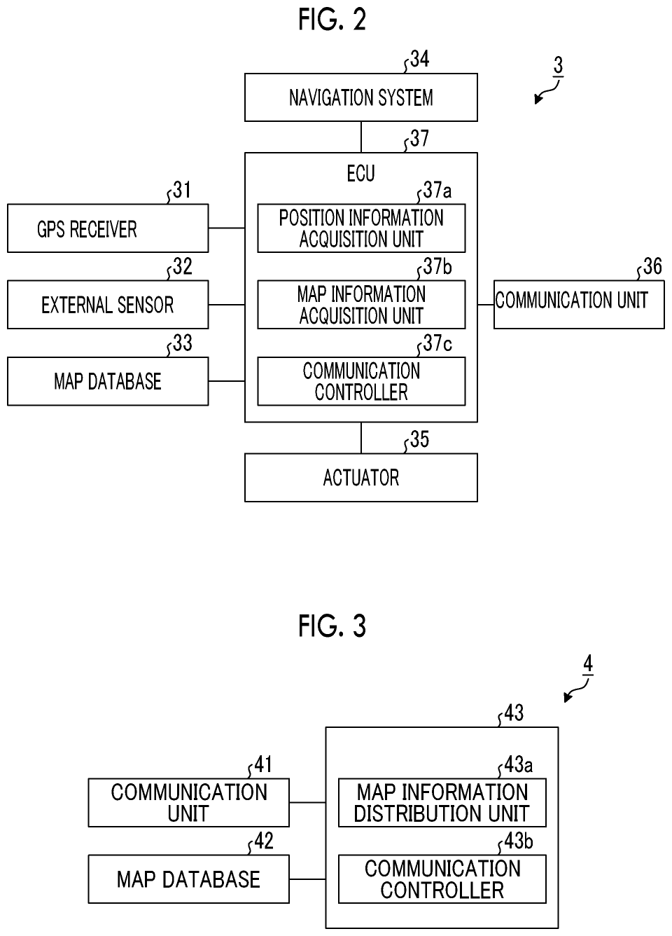

Next, the configuration of each vehicle 3 will be described with reference to FIG. 2.

FIG. 2 is a block diagram illustrating the configuration of each vehicle 3 illustrated in FIG. 1. As illustrated in FIG. 2, each vehicle 3 includes a global positioning system (GPS) receiver 31, an external sensor 32, a map database 33, a navigation system 34, an actuator 35, a communication unit 36, and an electronic control unit (ECU) 37.

The GPS receiver 31 functions as a position-measuring device configured to measure the position of the vehicle 3. The GPS receiver 31 measures the position (e.g., the latitude and longitude) of the vehicle 3 by receiving signals from three or more GPS satellites. The GPS receiver 31 outputs information regarding the measured position of the vehicle 3 to the ECU 37. Note that the vehicle 3 may measure the position of the vehicle 3 by the simultaneous localization and mapping (SLAM) technology, based on position information regarding stationary obstacles, such as utility poles, included in the map information stored in the map database 33 and results of detection performed by the external sensor 32.

The external sensor 32 includes image-capturing devices, a radar, and a lidar. The image-capturing devices are configured to capture images of outside circumstances surrounding the vehicle 3. The image-capturing devices are respectively provided on the backside of the windshield of the vehicle 3 and the rear surface of the vehicle 3. The image-capturing devices may be respectively provided on the right and left side surfaces of the vehicle 3. The image-capturing devices output, to the ECU 37, image information obtained by capturing images of the areas in front of and behind the vehicle 3. Each image-capturing device may be a monocular camera or a stereo camera. The stereo camera includes two image-capturing units disposed so as to reproduce binocular parallax. The image information obtained by the stereo camera includes information in the depth direction.

The radar detects an obstacle around the vehicle 3 by using radio waves (e.g., millimeter waves). The radar transmits a radio wave to an area around the vehicle 3 and receives the radio wave reflected by an obstacle, thereby detecting the obstacle. The radar outputs information regarding the detected obstacle to the ECU 37. Examples of obstacles include dynamic obstacles, such as bicycles and other vehicles, in addition to the stationary obstacles described above. The lidar detects an obstacle around the vehicle 3 by using light. The lidar transmits light to an area around the vehicle 3 and receives the light reflected by an obstacle to measure the distance to the reflection point, thereby detecting the obstacle. The lidar outputs information regarding the detected obstacle to the ECU 37. Note that it is not absolutely necessary to provide both the lidar and the radar.

The map database 33 is a database that stores map information. The map database 33 is provided in a storage device, such as a hard disk drive (HDD), mounted in the vehicle 3. The map database 33 can be connected to the server device 4 by wireless communication via the communication unit 36. The map database 33 periodically updates the map information based on the latest map information stored in the server device 4. The map information includes version information, road position information (position information regarding each lane), road shape information (e.g., curves, types of straight sections, and curvatures of the curves), road width information (lane width information), road speed limit information, and image information regarding areas around the road (three-dimensional information). Further, the map information includes position information regarding intersections and branch points, position information regarding stop lines, position information regarding pedestrian crossings, and position information regarding traffic lights. The map information may include road gradient information and road cant information. Furthermore, the map information may include position information and shape information regarding stationary obstacles, such as curbs, utility poles, poles, guardrails, walls, and buildings. The map information may include position information and shape information regarding road surface paintings, such as characters and marks drawn on road surfaces. Manholes may be included in road surface paintings. The map information may include information regarding signboards provided above the road and information regarding signs provided on the roadside.

The navigation system 34 calculates a target route from the current position of the vehicle 3 to a preset destination by a known method, based on the preset destination, the position of the vehicle 3 measured by the GPS receiver 31, and the map information stored in the map database 33, and provides route guidance along the target route. An occupant of the vehicle 3 operates an input button (or a touch panel) included in the navigation system 34, thereby setting a destination.

The actuator 35 is a device configured to control traveling of the vehicle 3. The actuator 35 includes a throttle actuator, a brake actuator, and a steering actuator. The throttle actuator controls the amount of air to be supplied to an engine (throttle valve opening degree) in response to a control signal from the ECU 37, thereby controlling the driving force of the vehicle 3. When the vehicle 3 is a hybrid vehicle, the driving force is controlled in response to a control signal transmitted from the ECU 37 to a motor serving as a power source, in addition to a control signal indicating the amount of air to be supplied to the engine. When the vehicle 3 is an electric vehicle, the driving force is controlled in response to a control signal transmitted from the ECU 37 to a motor serving as a power source. The motor serving as a power source in such cases is included in the actuator 35. The brake actuator controls a braking system in response to a control signal from the ECU 37, thereby controlling braking forces to be applied to wheels of the vehicle 3. The steering actuator controls driving of an assist motor included in an electric power steering system and configured to control steering torque, in response to a control signal from the ECU 37.

The communication unit 36 includes a wireless communication circuit and so forth for performing wireless communication. The communication unit 36 performs information communication with the server device 4 through the telecommunication network 2. The communication unit 36 may perform vehicle-to-vehicle communication with other vehicles capable of performing vehicle-to-vehicle communication. The communication unit 36 may perform road-to-vehicle communication with roadside transceivers provided along roads.

The ECU 37 is an electronic control unit including a central processor (CPU), a read-only memory (ROM), a random-access memory (RAM), a controller area network (CAN) communication circuit, and so forth. In the present embodiment, the ECU 37 loads computer programs stored in the ROM into the RAM and executes the computer programs loaded into the RAM by using the CPU, thereby functioning as a position information acquisition unit 37a, a map information acquisition unit 37b, and a communication controller 37c.

The position information acquisition unit 37a acquires information regarding the position of the vehicle 3 by using the GPS receiver 31. The map information acquisition unit 37b acquires map information from the server device 4 through the telecommunication network 2. The communication controller 37c controls information communication with the server device 4 through the telecommunication network 2.

Configuration of Server Device

Next, the configuration of the server device 4 will be described with reference to FIG. 3.

FIG. 3 is a block diagram illustrating the configuration of the server device 4 illustrated in FIG. 1. As illustrated in FIG. 3, the server device 4 includes a communication unit 41, a map database 42, and a server body 43.

The communication unit 41 includes a wireless communication circuit and so forth for performing wireless communication. The communication unit 41 performs information communication with the vehicle 3 through the telecommunication network 2.

The map database 42 is a database that stores the map information described above.

The server body 43 includes a known information processor. The server body 43 functions as a map information distribution unit 43a and a communication controller 43b when an internal processor executes computer programs. The map information distribution unit 43a distributes the map information stored in the map database 42 to the vehicles 3 through the telecommunication network 2. The communication controller 43b controls information communication with the vehicles 3 through the telecommunication network 2.

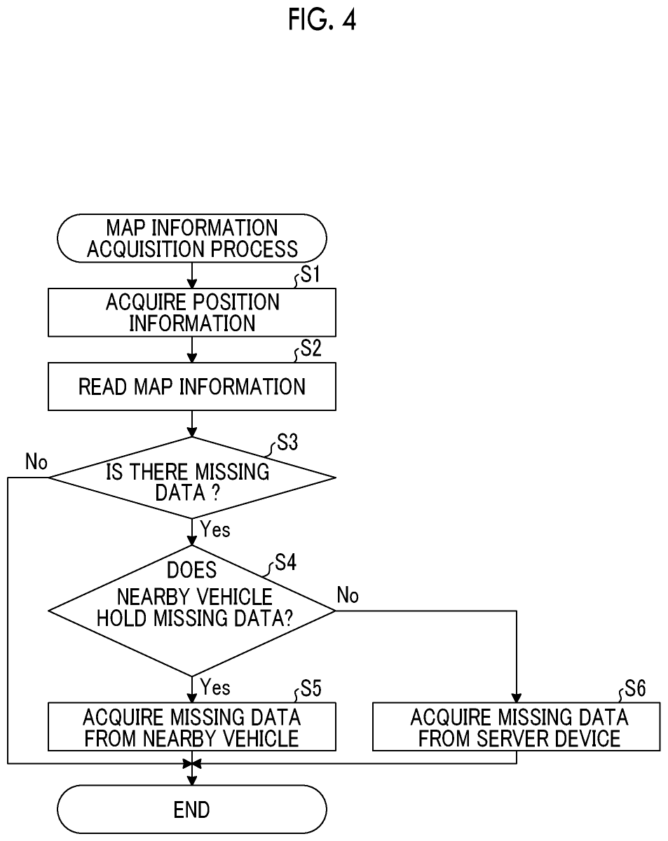

In the map information distribution system 1 having the foregoing configuration, each vehicle 3 executes a map information acquisition process described below, whereby the data traffic between the vehicle 3 and the server device 4 is reduced. Hereinafter, an operation of the vehicle 3 during execution of the map information acquisition process will be described with reference to a flowchart illustrated in FIG. 4.

Map Information Acquisition Process

FIG. 4 is a flowchart illustrating the procedure of the map information acquisition process according to the embodiment of the disclosure. In the flowchart illustrated in FIG. 4, the map information acquisition process starts at the timing when an ignition switch of a vehicle 3 (host vehicle) is switched from an off-state to an on-state, and then the map information acquisition process proceeds to step S1. While the ignition switch of the vehicle 3 (host vehicle) is in the on-state, the map information acquisition process is repeatedly executed every time a predetermined time has elapsed after the immediately preceding map information acquisition process ends.

In the processing of step S1, the position information acquisition unit 37a acquires the position information regarding the vehicle 3 (host vehicle) by using the GPS receiver 31. Thus, the processing of step S1 is completed, and the map information acquisition process proceeds to step S2.

In the processing of step S2, the map information acquisition unit 37b reads the map information regarding an area around the position of the vehicle 3 (host vehicle) acquired in the processing of step S1, from the map information stored in the map database 33. Thus, the processing of step S2 is completed, and the map information acquisition process proceeds to step S3.

In the processing of step S3, the map information acquisition unit 37b determines whether there is missing data in the map information read in the processing of step S2 (i.e., whether at least one piece of data is missing in the map information read in the processing of step S2). When the map information acquisition unit 37b determines that there is missing data in the map information (Yes in step S3), the map information acquisition unit 37b causes the map information acquisition process to proceed to step S4. On the other hand, when the map information acquisition unit 37b determines that there is no missing data in the map information (No in step S3), the map information acquisition unit 37b ends the map information acquisition process.

In the processing of step S4, the map information acquisition unit 37b determines whether there is a nearby vehicle holding the missing data (i.e., whether there is a nearby vehicle holding the data that is missing in the map information held by the vehicle 3 (host vehicle)) among nearby vehicles, by communicating with the nearby vehicles by vehicle-to-vehicle communication. When the map information acquisition unit 37b determines that there is a nearby vehicle holding the missing data (Yes in step S4), the map information acquisition unit 37b causes the map information acquisition process to proceed to step S5. On the other hand, when the map information acquisition unit 37b determines that there is no nearby vehicle holding the missing data (No in step S4), the map information acquisition unit 37b causes the map information acquisition process to proceed to step S6.

When no vehicle is present around the vehicle 3 (host vehicle), the map information acquisition unit 37b may cause the map information acquisition process to proceed to step S6. The map information acquisition unit 37b may communicate with a nearby vehicle holding the map information in a version newer than that of the map information that is held by the vehicle 3 (host vehicle), among nearby vehicles. The map information acquisition unit 37b may communicate with a nearby vehicle having a destination similar to the destination of the vehicle 3 (host vehicle), among nearby vehicles. The determination as to whether the above-described destinations are similar to each other may be made based on the destination set in the navigation system 34, for example. With this configuration, it is possible to increase the probability of acquiring the missing data from the nearby vehicles.

In the processing of step S5, the map information acquisition unit 37b acquires the missing data in the map information from the nearby vehicle. Thus, the processing of step S5 is completed, and the map information acquisition process ends.

In the processing of step S6, the map information acquisition unit 37b acquires the missing data in the map information from the server device 4 through the telecommunication network 2. Thus, the processing of step S6 is completed, and the map information acquisition process ends.

As is clear from the above description, in the map information acquisition process according to the embodiment of the disclosure, the vehicle 3 (host vehicle) determines whether there is missing data in the map information held by the vehicle 3 (host vehicle). When there is missing data in the map information, the vehicle 3 (host vehicle) determines whether a nearby vehicle holds the missing data by communicating with the nearby vehicle. When the nearby vehicle holds the missing data, the vehicle 3 (host vehicle) acquires the missing data from the nearby vehicle. When the nearby vehicle does not hold the missing data, the vehicle 3 (host vehicle) acquires the missing data from the server device 4. With this configuration, it is possible to avoid a situation where, every time there is missing data in the map information, the vehicle 3 (host vehicle) acquires the missing data from the server device 4. As a result, it is possible to reduce the data traffic between the vehicle 3 (host vehicle) and the server device 4.

While the example embodiment of the disclosure made by the inventors has been described, the disclosure is not limited by the description and the drawings according to the embodiment, which are part of the disclosure of the disclosure. In other words, other embodiments, examples, and operation techniques that can be achieved by those skilled in the art and the like based on the foregoing embodiment fall within the scope of the disclosure.

What is claimed is:

1. A map information distribution system in which a server device distributes map information to a vehicle through a telecommunication network, wherein
the vehicle includes a control device configured to:
determine whether there is missing data in the map information held by the vehicle;
determine, when there is missing data in the map information held by the vehicle, whether a nearby vehicle holds the missing data by communicating with the nearby vehicle;
acquire the missing data from the nearby vehicle, when the nearby vehicle holds the missing data; and
acquire the missing data from the server device, when the nearby vehicle does not hold the missing data.

2. The map information distribution system according to claim 1, wherein the control device communicates with a nearby vehicle holding map information in a version newer than a version of the map information held by the vehicle, among nearby vehicles.

3. The map information distribution system according to claim 1, wherein the control device communicates with a nearby vehicle having a destination similar to a destination of the vehicle, among nearby vehicles.

4. A vehicle comprising a control device configured to:
determine whether there is missing data in map information held by the vehicle;
determine, when there is missing data in the map information held by the vehicle, whether a nearby vehicle holds the missing data by communicating with the nearby vehicle;
acquire the missing data from the nearby vehicle, when the nearby vehicle holds the missing data; and
acquire the missing data from a server device, when the nearby vehicle does not hold the missing data.
